(19) United States
(12) Patent Application Publication
(10) Pub. No.: US 2021/0154071 A1
(43) Pub. Date: May 27, 2021

(54) NURSING BED-CHAIR ASSEMBLY

(71) Applicant: Wuyi University, Jiangmen (CN)

(72) Inventors: Rongwei Ye, Jiangmen (CN); Juntong Fang, Jiangmen (CN); Chuanyue Gao, Jiangmen (CN); Xiaodan Wu, Jiangmen (CN)

(21) Appl. No.: 17/069,354

(22) Filed: Oct. 13, 2020

(30) Foreign Application Priority Data
Nov. 22, 2019 (CN) 2019111594824

(51) Int. Cl. A61G 7/10; A61G 5/10

(52) U.S. Cl. CPC A61G 7/1059; A61G 5/10; A61G 7/1046

(57) ABSTRACT

Disclosed is a nursing bed-chair assembly, which includes a nursing bed and a wheelchair. The nursing bed includes a bed frame, and a connecting mechanism and an interfacing mechanism which are mounted on the bed frame. The butt-joint mechanism includes a guide rail, a butt-joint fixing plate and butt-joint members. The guide rail is mounted on the bed frame, the butt-joint fixing plate is slidably mounted on the guide rail, and the butt-joint members are mounted on the butt-joint fixing plate. The wheelchair includes a wheelchair frame, a backrest and a seat plate which are mounted on the wheelchair frame, main wheels rotatablely mounted on both sides of the wheelchair frame, armrests, and butt-joint portions in butt joint with the butt-joint members.

### CROSS-REFERENCE TO RELATED APPLICATIONS

This application is based on and claims the benefit of priority from Chinese Patent Application No. 2019111594824, filed on Nov. 22, 2019, the entirety of which is incorporated by reference herein.

### TECHNICAL FIELD

The present disclosure relates generally to the field of nursing instruments, and more particularly to a nursing bed-chair assembly.

### BACKGROUND

Both wheelchairs and nursing beds are frequently-used nursing instruments.

In order to facilitate patients to go out for activities, see a doctor and transport, patients often need to be transferred from nursing beds to wheelchairs to achieve the above purposes.

Existing wheelchairs and nursing beds have poor compatibility, so it is difficult and inflexible for the wheelchair to get in or out of the nursing bed. If a patient needs to transfer from a nursing bed to a wheelchair, the wheelchair needs to be moved to the vicinity of the nursing bed. There is no butt-joint device arranged on the existing wheelchair or the nursing bed. The wheelchair may shift and shake when the patient is transferred from the nursing bed to the wheelchair because the wheelchair is slidable, so it is difficult for the patient to move from the nursing bed to the wheelchair by himself/herself, and a secondary injury may be caused to the patient if he/she is not careful.

### SUMMARY

The present disclosure aims to address at least one of the technical problems existing in the existing art. Therefore, the present disclosure provides a nursing bed-chair assembly, to avoid a secondary injury to a patient caused by shifting and shaking of the wheelchair when the patient is transferred from the nursing bed to the wheelchair.

A nursing bed-chair assembly according to the present disclosure, including a nursing bed and a wheelchair. The nursing bed includes a bed frame, and a connecting mechanism and a butt-joint mechanism which are mounted on the bed frame. The butt-joint mechanism includes a guide rail, a butt-joint fixing plate and butt-joint members. The guide rail is mounted on the bed frame, the butt-joint fixing plate is slidably mounted on the guide rail, and the butt-joint members are mounted on the butt-joint fixing plate. The wheelchair includes a wheelchair frame, a backrest and a seat plate which are mounted on the wheelchair frame, main wheels rotatablely mounted on both sides of the wheelchair frame, armrests, and butt-joint portions in butt joint with the butt-joint members. The armrests are mounted on the wheelchair frame retractably and are located on both sides of the seat plate, connecting portions capable of being connected with the connecting mechanism are arranged at ends of the armrests, and the butt-joint portions are arranged on both sides of a front end of the wheelchair frame and are located below the armrests.

The nursing bed-chair assembly according to embodiments of the present disclosure at least has the following beneficial effects: a connecting mechanism and a butt-joint mechanism are arranged on the bed frame of the nursing bed of the present disclosure, armrests and butt-joint portions are respectively arranged on the wheelchair frame of the wheelchair in correspondence, connecting portions are arranged at the ends of the armrests and are capable of being detachably connected with the connecting mechanism, the butt-joint portions are in butt joint with the butt-joint mechanism, the connecting portions and the butt-joint portions are respectively connected with the connecting mechanism and the butt-joint mechanism to connect upper and lower portions of a front end of the wheelchair with the nursing bed so as to form a relatively stable connection, so that a secondary injury to a patient caused by shifting and shaking of the wheelchair when the patient is transferred from the nursing bed to the wheelchair can be avoided, and the patient can transfer to the wheelchair smoothly by using the armrests as support. Moreover, the armrests can be expanded and contracted, and thus can be applied for butt joint of various nursing beds. Meanwhile, different turning-round spaces can be formed between the wheelchair and the nursing bed by adjusting the expanding and contracting lengths of the armrests, to be suitable for patients with different body sizes. In addition, through the butt joint between the wheelchair and the nursing bed, the patient can transfer to the wheelchair by himself/herself, thereby reducing the nursing pressure of caregivers and their families. Meanwhile, the butt-joint mechanism includes a guide rail. Relative positions of the butt-joint members on the butt-joint fixing plate and the butt-joint potions of the wheelchair can be adjusted through the guide rail, making it adapted to different types of wheelchairs, and making the use more flexible and convenient.

According to some embodiments of the present disclosure, the butt-joint members are electromagnets.

According to some embodiments of the present disclosure, the butt-joint members are magnets which are attracted and fixed to the electromagnets. In the solution, the electromagnets are energized through the magnets located at the front end of the wheelchair frame. If the patient needs to transfer from the nursing bed to the wheelchair, the wheelchair is moved to the vicinity the nursing bed, so that the magnets on both sides of the front end of the wheelchair are attracted and fixed to the electromagnets on the nursing bed, and then the armrests are adjusted in length by expanding and contracting the armrests to the connecting portions with the connecting mechanism, and after the magnets are attracted and fixed to the electromagnets and the connecting portions are connected with the connecting mechanism, the butt joint between the wheelchair and the nursing bed is completed. The magnets are simple in structure, low in cost and reliable after attracting to the electromagnets.

According to some embodiments of the present disclosure, the butt-joint portions are detachably mounted on both sides of the front end of the wheelchair frame. The butt-joint portions in the solution can be detachably mounted, if the butt-joint portions are damaged, the butt-joint portions may be replaced without replacing the wheelchair, and thereby reducing the maintenance cost of the butt-joint portions.

According to some embodiments of the present disclosure, the connecting mechanism is a connecting tube hung on the bed frame.

According to some embodiments of the present disclosure, a lower portion of each of the connecting portions is provided with a connecting opening that connects with the connecting tube.

According to some embodiments of the present disclosure, the nursing bed further includes pulleys which are mounted at the bottom of the bed frame. In the scheme, the pulleys are arranged under the nursing bed, thereby being convenient for moving and transferring the nursing bed.

According to some embodiments of the present disclosure, the wheelchair further includes universal wheels which are mounted at the front end of the wheelchair frame and located on both sides of the butt-joint portion. In the solution, the universal wheels are arranged at the front end of the wheelchair frame, which can facilitate the reversing of the wheelchair and make the use of the wheelchair more flexible.

Additional aspects and advantages of the present disclosure will be set forth in part in the following description, and in part will become apparent from the following description, or will be learned through the practice of the present disclosure.

### BRIEF DESCRIPTION OF THE DRAWINGS

The above and/or additional aspects and advantages of the present disclosure will become apparent and readily understood from the description of the embodiments taken in conjunction with the following drawings, in which:

FIG. 1 is an overall structural schematic diagram of a nursing bed-chair assembly of the present disclosure.

FIG. 2 is a structural schematic diagram of a nursing bed of the present disclosure.

FIG. 3 is a structural schematic diagram of a wheelchair of the present disclosure.

FIG. 4 is a schematic diagram showing connection between the connecting portions and the connecting mechanism of the present disclosure.

### DETAILED DESCRIPTION

Embodiments of the present disclosure will be described below in detail. Examples of the embodiments are shown in the Figures, wherein same or similar reference numbers refer to same or similar elements or elements having same or similar functions. The embodiments described below with reference to the accompanying drawings are exemplary, and are only used for explaining the present disclosure, not used for limiting the present disclosure.

It should be understood in the description of the present disclosure that terms such as “upper”, “lower”, “front”, “back”, “outer”, “inner” etc. indicate direction or position relationships shown based on the drawings, and are only intended to facilitate the description of the present disclosure and the simplification of the description rather than to indicate or imply that the indicated device or element must have a specific direction or constructed and operated in a specific direction, and therefore, shall not be understood as a limitation to the present disclosure.

In the description of the present disclosure, the meaning of several refers to one or more, the meaning of a plurality of refers to two or more, greater than, less than and more than are understood as not including the number itself, and above, below, and within are understood as including the number itself. The terms such as “first” and “second” are only used for the purpose of differentiating technical features, rather than being understood to indicate or imply relative importance or hint the number of indicated technical features or hint the order of the indicated technical features.

In the description of the present disclosure, terms such as “arrange”, “mount,” and “connect” shall be understood in broad sense. Those skilled in the technical field can reasonably determine the specific meanings of the above words in the present disclosure in combination with the specific contents of the technical solution.

In order to have a clearer understanding of the technical features, objectives and effects of the present disclosure, the specific embodiments of the present disclosure will be described in detail with reference to the drawings.

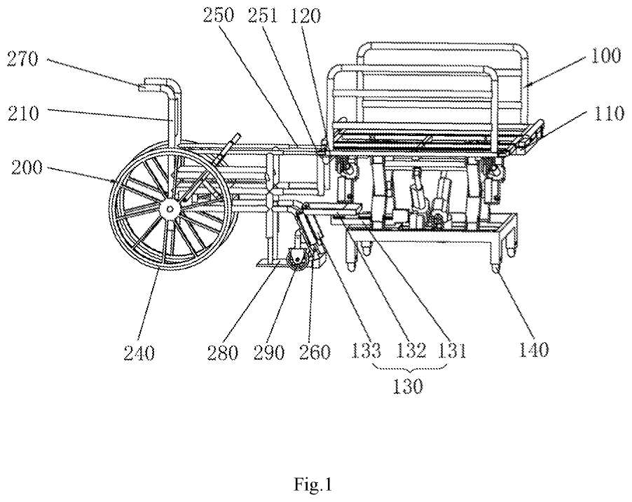

Referring to FIGS. 1 to 3, the present disclosure provides a nursing bed-chair assembly, which includes a nursing bed 100 and a wheelchair 200. Specifically, the nursing bed 100 includes a bed frame 110, a connecting mechanism 120 and a butt-joint mechanism 130, and the wheelchair 200 includes a wheelchair frame 210, a backrest 220, a seat plate 230, main wheels 240, armrests 250 and butt-joint portions 260. The connecting mechanism 120 and the butt-joint mechanism 130 are mounted on the bed frame 110. The backrest 220 and the seat plate 230 are mounted on the wheelchair frame 210, the main wheels 240 are rotatablely mounted on the wheelchair frame 210 and are located on both sides of seat plate 230, the armrests 250 are mounted on the wheelchair frame 210 retractably and are located at the two sides of the seat plate 230, connecting portions 251 are arranged at ends of the armrest 250, and the butt-joint portions 260 are arranged on both sides of a front end of wheelchair frame 210 and are located below the armrests 250. If a patient needs to transfer from the nursing bed 100 to the wheelchair 200, the wheelchair 200 is moved to the vicinity of the nursing bed 100, so that the butt-joint portions 260 are in butt-joint with the butt-joint mechanism 130, and the armrests 250 are extended and contracted to adjust the position between the connecting portions 251 and the connecting mechanism 120, so as to connect the connecting portions 251 with the connecting mechanism 120. After the connecting portions 251 are connected with the connecting mechanism 120 and the butt-joint portions 260 are in butt-joint with the butt-joint mechanism 130, upper and lower portions of a front end of the wheelchair 200 are connected with the nursing bed 100 respectively, forming a relatively stable structure. When the patient transfers from the nursing bed 100 to the wheelchair 200, the wheelchair 200 will not shift and shake, thereby ensuring the safety of the patient and avoiding the secondary injury to the patient.

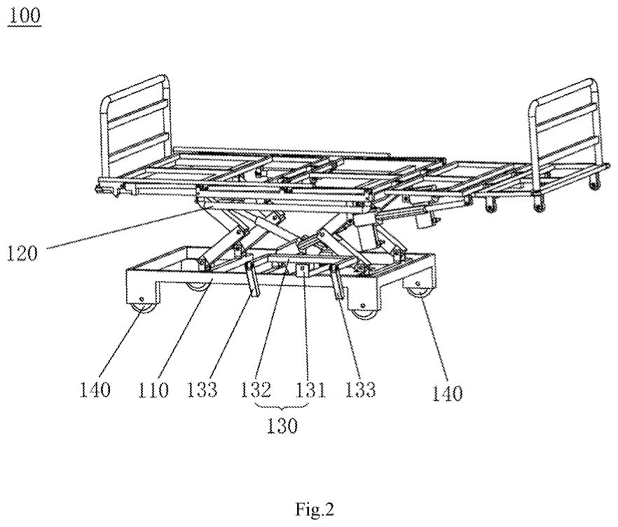

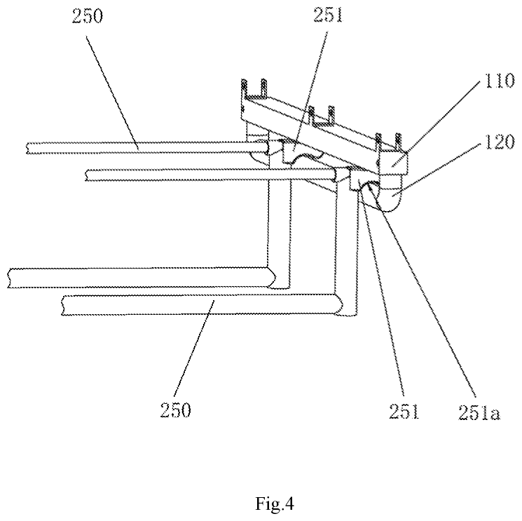

Referring to FIGS. 2 to 4, in the present embodiment, the connecting mechanism 120 is a connecting tube hung on the bed frame 110. A lower portion of each of the connecting portions 251 of the armrests 250 is provided with an arc-shaped connecting opening 251a. When the armrests 250 are connected with the nursing bed 100, the connecting openings 251a of the connecting portions 251 overlap with the connecting tube, so that the wheelchair 200 cannot slide relative to the nursing bed 100, and thus the upper portion of the front end of the wheelchair 200 is connected with the nursing bed 100. Certainly, in addition to using the connecting openings 251a to connect with the connecting tube, the structures of the connecting portions 251 and the connecting mechanism 120 may be changed, then the connecting portions 251 and the connecting mechanism 120 may be connected by buckling, snap-fitting or clamping, and the connecting portions 251 and the connecting mechanism 120 may be connected by adhesion.

Referring to FIG. 2, in the present embodiment, the butt-joint mechanism 130 includes a guide rail 131, a butt-joint fixing plate 132 and butt-joint members 133. Two butt-joint members 133 are provided and are mounted on both sides of the butt-joint fixing plate 132, and the butt-joint fixing plate 132 is slidably mounted on the guide rail 131. Specifically, the guide rail 131 is provided with a slide block on which the butt-joint fixing plate 132 is mounted, and the guide rail 131 is mounted on the bed frame 110. The nursing bed 100 is further provided with a driving device which is electrically connected with the slide block and is capable of driving the slide block to slide. By driving the slide block to slide along the guide rail 131, relative positions between the butt-joint members 133 and the butt-joint portions 260 may be adjusted to ensure the butt joint between the nursing bed 100 and the wheelchair 200.

Specifically, in the present embodiment, the butt-joint portions 260 are magnets, and correspondingly, the butt-joint members 133 are electromagnets. The butt-joint portions 260 and the butt-joint members 133 are both two in number. The magnets are tied to the two sides of the front end of the wheelchair frame 210 and are located below the armrests 250. In the present embodiment, the butt-joint portions 260 are tied to the two sides of the front end of the wheelchair frame 210 of the wheelchair 200 in a binding manner, and the butt-joint portions 260 are detachable. If the butt-joint portions 260 are damaged, the butt-joint portions 260 may be replaced without replacing the whole wheelchair 200, reducing the maintenance difficulty. Of course, the butt-joint portions 260 may also be adhered to the wheelchair 200 by means of an adhesive or can be mounted on the wheelchair 200 by screws as well. If the patient needs to transfer from the nursing bed 100 to the wheelchair 200, the wheelchair 200 is moved to the vicinity of the nursing bed 100, the electromagnets are energized, and the slide block slides along the guide rail 131 to adjust the relative distance between the electromagnets and the magnets. The magnets gradually approach the electromagnets, and are attracted and fixed to the electromagnets to connect the lower portion of the front end of the wheelchair 200 with the nursing bed 100. The current passing through the electromagnets may be adjusted to change the magnetism of the electromagnets, so as to ensure the attraction strength between the electromagnets and the magnets, and prevent the wheelchair 200 from shifting and shaking due to the disengagement between the electromagnets and the magnets caused by an excessive force during the transfer of the patient to the wheelchair. Of course, the butt-joint portions 260 and the butt-joint members 133 may adopt the same structure as the connecting portions 251 and the connecting mechanism 120 respectively. The butt-joint portions 260 and the butt-joint members 133 may also be buckled, snap-fitted or adhered to connect the lower portion of the front end of the wheelchair 200 with the nursing bed 100.

Referring to FIG. 2, in order to facilitate the movement and transport of the nursing bed 100, the nursing bed 100 is further provided with pulleys 140 which are mounted at the bottom of the bed frame 110. The nursing bed 100 can be moved and transported at random through the pulleys 140, making the use of the nursing bed 100 more convenient.

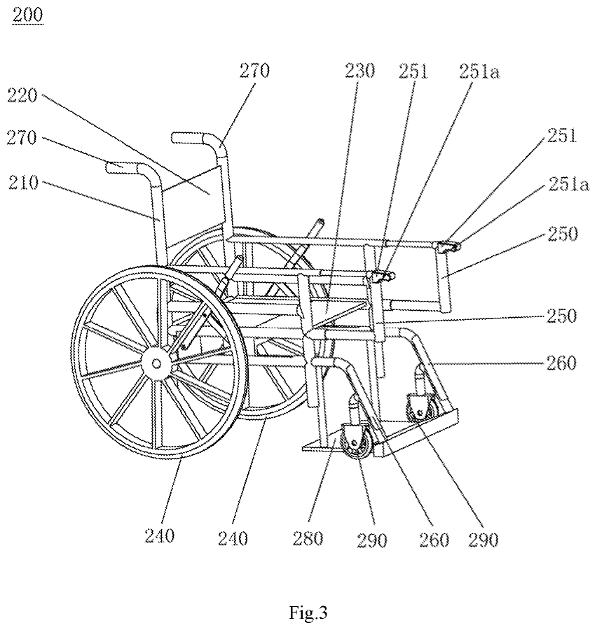

Referring to FIG. 3, in order to facilitate caregivers or family members to move the patient, handles 270 are mounted on the wheelchair frame 210 on both sides of the back of the backrest 220. In the present embodiment, the handles 270 are integrated with the wheelchair frame 210 into one piece. Of course, the handles 270 can be mounted on the wheelchair frame 210 by welding, and the handles 270 can also be mounted on the wheelchair frame 210 by connecting. The mounting mode of the handles 270 is not limited to this.

In the present embodiment, the backrest 220 is mounted on the wheelchair frame 210 in a wide strip shape. The backrest 220 is made of woven cloth, and an angle of the backrest 220 is not adjustable. Of course, the backrest 220 may be made of other materials, and the angle of the backrest 220 may be set to be adjustable to improve the comfort of the patient when using the wheelchair 200.

Referring back to FIG. 3, to further improve the comfort of the patient when using the wheelchair 200, a pedal 280 is mounted at the front end of the wheelchair frame 210, between the two interfacing portions 260. The pedal 280 is of a plate-shaped structure, and both sides of the pedal 280 are respectively connected with the wheelchair frame 210, so that the patient may put his/her feet on the pedal 280 without suspending the feet, thereby improving the comfort of the patient.

Meanwhile, the wheelchair 200 is also provided with universal wheels 290 which are rotatablely mounted at the front end of the wheelchair frame 210 and are located at the two sides of the interfacing portions 260. Two universal wheels 290 are provided. A moving direction of the wheelchair 200 may be adjusted through the universal wheels 290, making the use of the wheelchair 200 more flexible, and avoiding the secondary injury to the patient caused by the difficulty of changing the moving direction because of only having the main wheels 240.

Embodiments of the present disclosure are described above in detail with reference to the accompanying drawings. However, the present disclosure is not limited to the above embodiments. Within the scope of the knowledge possessed by those skilled in the technical field, various changes can be made without departing from the purpose of the present disclosure.

We claim:

1. A nursing bed-chair assembly, comprising:
a nursing bed comprising a bed frame, and a connecting mechanism and a butt-joint mechanism mounted on the bed frame, the butt-joint mechanism comprising a guide rail, a butt-joint fixing plate and butt-joint members, wherein the guide rail is mounted on the bed frame, the butt-joint fixing plate is slidably mounted on the guide rail, and the butt-joint members are mounted on the butt-joint fixing plate; and
a wheelchair comprising a wheelchair frame, a backrest and a seat plate mounted on the wheelchair frame, main wheels rotatablely mounted on both sides of the wheelchair frame, armrests, and butt-joint portions in butt joint with the butt-joint members, wherein the armrests are mounted on the wheelchair frame retractably and are located on both sides of the seat plate, connecting portions capable of being connected with the connecting mechanism are arranged at ends of the armrests, and the butt-joint portions are arranged on both sides of a front end of the wheelchair frame and are located below the armrests.

2. The nursing bed-chair assembly of claim 1, wherein the butt-joint member is electromagnet.

3. The nursing bed-chair assembly of claim 2, wherein the butt-joint members are magnets attracted and fixed to the electromagnets.

4. The nursing bed-chair assembly of claim 1, wherein the butt-joint portions are detachably mounted on both sides of the front end of the wheelchair frame.

5. The nursing bed-chair assembly of claim 1, wherein the connecting mechanism is a connecting tube hung on the bed frame.

6. The nursing bed-chair assembly of claim 5, wherein a lower portion of each of the connecting portions is provided with a connecting opening that connects with the connecting tube.

7. The nursing bed-chair assembly of claim 1, wherein the nursing bed further comprises pulleys which are mounted at a bottom of the bed frame.

8. The nursing bed-chair assembly of claim 1, wherein the wheelchair further comprises universal wheels which are mounted at the front end of the wheelchair frame and located at two sides of the butt-joint portions.
